(19) United States
(12) Patent Application Publication
(10) Pub. No.: US 2003/0028133 A1
(43) Pub. Date: Feb. 6, 2003

(54) Back scratch relaxer

(76) Inventor: Michael Dylan Pollock, Raleigh, NC (US)

Correspondence Address: Michael Dylan Pollock, 5336 Waynes Street Apt A, Raleigh, NC, 27606, US

(21) Appl. No.: 09/922,606

(22) Filed: Aug. 6, 2001

(51) Int. Cl. A61H 7/00

(52) U.S. Cl. 601/84

(57) ABSTRACT

This Back Scratch Relaxer is new in the art in which the invention pertains because it is used while laying down and can be left on top of the body indefinately while the mechanical aspect of the machine works with no input from the person using it. The motor drives the chains along the desired part of the body and the form of relaxation is given.

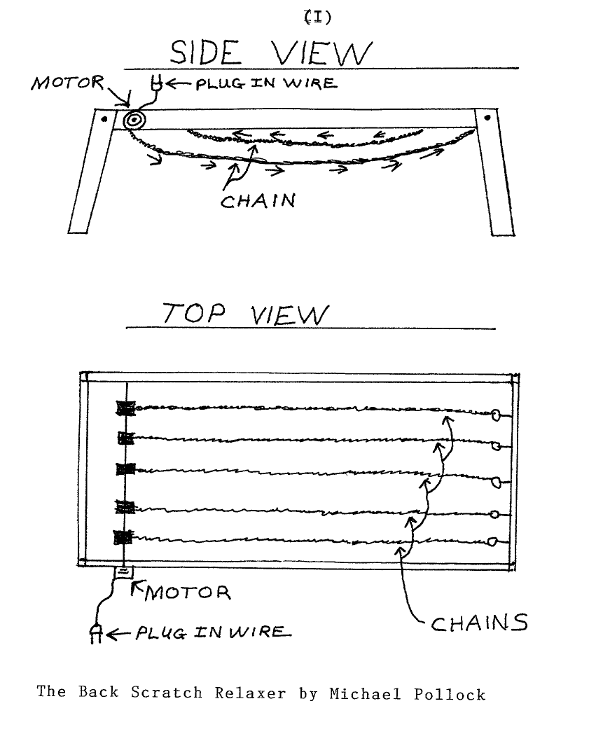

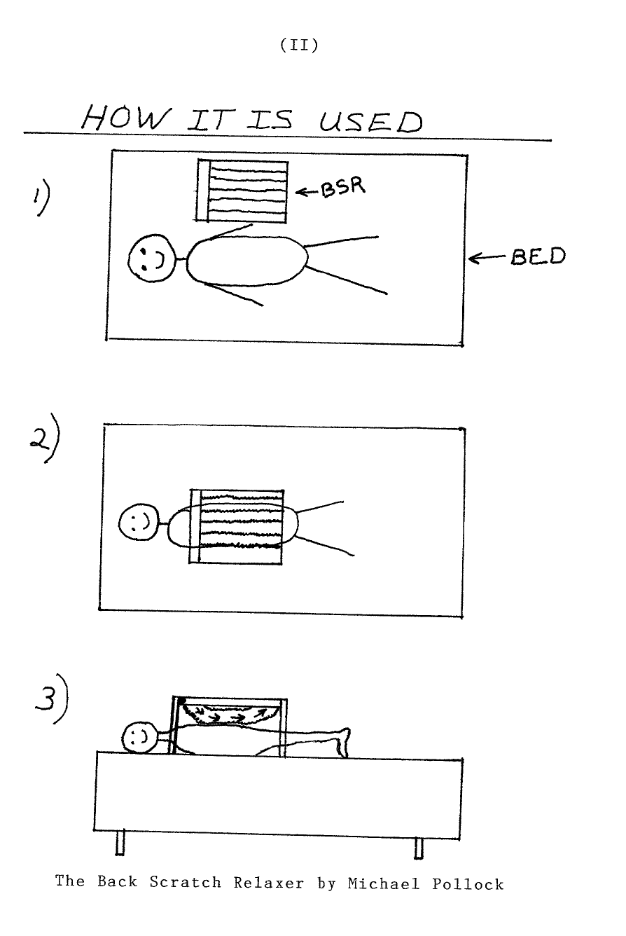

### BACKGROUND

The BACK SCRATCH RELAXER is a machine that is used while laying down. It simply has four legs and is layed on top of the person while the small, light chains are pulled along by a small motor. However, since it is stationary on the surface on which it is laying, you can adjust your body anywhere below it to receive the effect anywhere on the body. It uses a small electric motor to drive the chains and it has an infinitely adjustable speed controller to adjust the speed of the chains. Contrary to what the name may suggest, this machine is to be used to relax people with the soothing action of the chains.

### DESCRIPTION

The BACK SCRATCH RELAXER consists of a rectangular frame with four legs attached. The chains are connected to the frame by two rollers from which the chains hang down in order to make contact with the body. As the motor is turned on, the chains are pulled along the body giving the desired effect. Pictures are included to fully describe the machine. Page I shows the side and top view of the machine in detail and page II shows the procedure as how to apply the machine. On page 2 of the description, the pictures will be described in order.

DESCRIPTION of how the BACK SCRATCH RELAXER is used.

1) Place the BACK SCRATCH RELAXER on the surface on which you will be. Have it plugged in with the adjusting speed controller near by. Lay down beside the machine so that you can easily pick it up and lay it down on top of yourself.

2) Put the machine on top of you and, since it is not on, pick up the speed controller and turn it on the desired speed.

3) Move about underneath the machine and enjoy the soothing chains wherever you want on your body.

(refer to page II of the drawings for this page)

1. What I claim as my invention is that this product is one that can be used as the person is lying down and is able to work without any more effort from the person. Most other products are used by the arm putting the product behind the body and letting it do its thing. The BACK SCRATCH RELAXER is put on the bed on top of you, turned on, and requires no more input from the person so the person can even fall asleep if so desired. This design of having the machine on top of you while it is working is unprecidented and therefore is the invention.
